(19) United States
(12) Patent Application Publication
(10) Pub. No.: US 2021/0331245 A1
(43) Pub. Date: Oct. 28, 2021

(54) METHOD OF MONITORING AN ADDITIVE MANUFACTURING PROCESS, ADDITIVE MANUFACTURING METHOD, APPARATUS FOR MONITORING AN ADDITIVE MANUFACTURING PROCESS AND ADDITIVE MANUFACTURING APPARATUS

(71) Applicant: MITSUBISHI HEAVY INDUSTRIES, LTD., Tokyo (JP)

(72) Inventors: Ryuichi NARITA, Tokyo (JP); Shuji TANIGAWA, Tokyo (JP); Yasuyuki FUJIYA, Tokyo (JP); Claus THOMY, Bremen (DE); Dieter TYRALLA, Bremen (DE); Thomas SEEFELD, Bremen (DE)

(21) Appl. No.: 17/233,752

(22) Filed: Apr. 19, 2021

(30) Foreign Application Priority Data
Apr. 27, 2020 (JP) 2020-078740

(51) Int. Cl. B22F 10/368; B22F 10/85; B22F 12/49; B22F 12/90; B22F 10/28; B33Y 10/00; B33Y 30/00; B33Y 50/02

(52) U.S. Cl. CPC B22F 10/368; B22F 10/85; B22F 12/49; B22F 12/90; B22F 2203/11; B33Y 10/00; B33Y 30/00; B33Y 50/02; B22F 10/28

(57) ABSTRACT

A method of monitoring an additive manufacturing process according to at least one embodiment of the present disclosure includes the steps of acquiring information on a temperature of a region upstream of a melt pool in a scanning direction of an energy beam, the melt pool being formed by irradiating a raw material with the energy beam, acquiring a parameter indicating a cooling rate of the region based on the information on the temperature, and determining a formation status based on the parameter.

### CROSS-REFERENCE TO RELATED APPLICATIONS

This application claims the benefit of priority to Japanese Patent Application Number 2020-078740 filed on Apr. 27, 2020. The entire contents of the above-identified application are hereby incorporated by reference.

### TECHNICAL FIELD

The disclosure relates to a method of monitoring an additive manufacturing process, an additive manufacturing method, an apparatus for monitoring an additive manufacturing process, and an additive manufacturing apparatus.

### RELATED ART

The additive manufacturing method for performing additive manufacturing of three-dimensional objects is used as a manufacturing method for various metal products. In manufacturing a metal product by the additive manufacturing method, a metal powder as a material is melted by an energy beam such as a laser beam and then solidified to form a three-dimensional product (e.g., see JP 6405028 B).

### SUMMARY

In the formation of a metal product by an additive manufacturing method, the cooling rate of a bead formed by melting metal powder with an energy beam is easily affected by the temperature of a formed object around the bead. In addition, in the formation of the metal product by the additive manufacturing method, since the metal powder serving as the material is heated by the energy beam as described above, heat easily accumulates in the formed object. Therefore, in the formation of the metal product by the additive manufacturing method, the cooling rate of the bead is likely to change (decrease).

The cooling rate of the bead affects the state of the bead fiber. Therefore, in order to keep the cooling rate of the bead within an appropriate range, the additive manufacturing process is preferably monitored based on information on the cooling rate of the bead.

In view of the circumstances described above, an object of at least one embodiment of the present disclosure is to monitor an additive manufacturing process in additive manufacturing to contribute to quality improvement of a formed object.

(1) A method of monitoring an additive manufacturing process according to at least one embodiment of the present disclosure includes the steps of, acquiring information on a temperature of a region upstream of a melt pool in a scanning direction of an energy beam, the melt pool being formed by irradiating a raw material with the energy beam, acquiring a parameter indicating a cooling rate of the region based on the information on the temperature, and determining a formation status based on the parameter.

(2) An additive manufacturing method according to at least one embodiment of the present disclosure includes the steps of irradiating a raw material with an energy beam, and determining a formation status by using the method of monitoring an additive manufacturing process of the above method 1).

(3) An apparatus for monitoring an additive manufacturing process according to at least one embodiment of the present disclosure includes, an information acquisition unit configured to acquire information on a temperature of a region upstream of a melt pool in a scanning direction of an energy beam, the melt pool being formed by irradiating a raw material with the energy beam, a parameter acquisition unit configured to acquire a parameter indicating a cooling rate of the region based on the information on the temperature of the region, and a determination unit configured to determine a formation status based on the parameter.

(4) An additive manufacturing apparatus according to at least one embodiment of the present disclosure includes an energy beam irradiation unit capable of irradiating a raw material with an energy beam, and the apparatus for monitoring an additive manufacturing process according to the above configuration (3).

According to at least one embodiment of the present disclosure, it is possible to contribute to improve the quality of a formed object in additive manufacturing.

### BRIEF DESCRIPTION OF DRAWINGS

The disclosure will be described with reference to the accompanying drawings, wherein like numbers reference like elements.

FIG. 1 is a schematic diagram illustrating an overall configuration of an additive manufacturing apparatus, as an apparatus to which an additive manufacturing method according to at least one embodiment of the present disclosure is applicable.

FIG. 2 is a schematic overall configuration diagram of a light beam irradiation unit according to some embodiments.

FIG. 3 is a diagram illustrating an overall configuration of an apparatus for monitoring an additive manufacturing process included in the additive manufacturing apparatus according to some embodiments.

FIG. 4 is a diagram schematically illustrating a temperature distribution, of a melt pool on the powder bed and the region in the vicinity thereof, measured during shaping by a thermometer according to some embodiments.

FIG. 5 is an enlarged schematic view of a region where a melt pool appears in the measurement region illustrated in FIG. 4.

FIG. 6 is a diagram for describing contents of processing in a parameter acquisition unit.

FIG. 7 is a flowchart illustrating a processing procedure of an additive manufacturing method when a formed object is formed by an additive manufacturing apparatus including an apparatus for monitoring according to some embodiments.

FIG. 8 is a flowchart illustrating a processing procedure of a subroutine of a formation status determination step.

### DESCRIPTION OF EMBODIMENTS

Hereinafter, some embodiments of the present disclosure will be described with reference to the accompanying drawings. It is intended, however, that dimensions, materials, shapes, relative positions or the like of the components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” or “coaxial” shall not be construed as indicating only the arrangement in a strict literal sense, but also includes a state where the arrangement is relatively displaced by a tolerance, or by an angle or a distance within a range in which it is possible to achieve the same function.

For instance, an expression of an equal state such as “same”, “equal”, “uniform” or the like shall not be construed as indicating only the state in which the feature is strictly equal, but also includes a state in which there is a tolerance or a difference within a range where it is possible to achieve the same function.

Further, for instance, an expression of a shape such as a rectangular shape, a cylindrical shape or the like shall not be construed as only the geometrically strict shape, but also includes a shape with unevenness, chamfered corners or the like within the range in which the same effect can be achieved.

On the other hand, an expression such as “provided”, “comprise”, “contain”, “include”, or “have” are not intended to be exclusive of other components.

Additive Manufacturing Apparatus 1

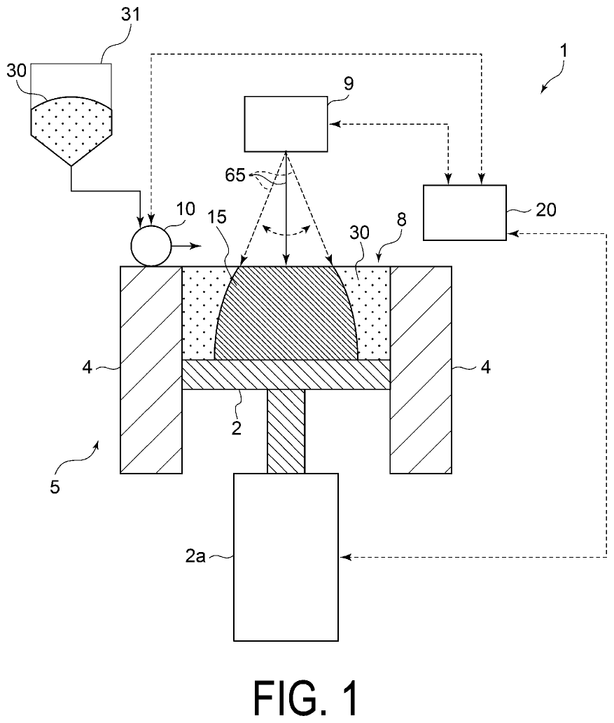

FIG. 1 is a schematic diagram illustrating an overall configuration of an additive manufacturing apparatus 1, as an apparatus to which an additive manufacturing method according to at least one embodiment of the present disclosure is applicable.

The additive manufacturing apparatus 1 is an apparatus for manufacturing a three-dimensional formed object 15 by performing additive manufacturing by irradiating a metal powder as a raw material powder laid in layers with a light beam 65 as an energy beam, and can perform additive manufacturing by a powder bed method.

The additive manufacturing apparatus 1 illustrated in FIG. 1 can form, for example, a rotor blade or a stator vane of a turbine such as a gas turbine or a steam turbine, or a component such as a combustor basket, a transition pipe or a nozzle of a combustor.

The additive manufacturing apparatus 1 illustrated in FIG. 1 includes a storage unit 31 for raw material powder 30. The additive manufacturing apparatus 1 illustrated in FIG. 1 includes a powder bed forming unit 5 including a base plate 2 on which a powder bed 8 is formed by the raw material powder 30 supplied from the storage unit 31. The additive manufacturing apparatus 1 illustrated in FIG. 1 includes an energy beam irradiation unit 9 (an example of an irradiation unit) capable of irradiating the powder bed 8 with the light beam 65 as an energy beam. In the following description, the energy beam irradiation unit 9 is also referred to as a light beam irradiation unit 9. The additive manufacturing apparatus 1 illustrated in FIG. 1 includes a control device 20 capable of controlling a powder laying unit 10, a drive cylinder 2a of the base plate 2, and the light beam irradiation unit 9, which will be described later.

The base plate 2 serves as a base on which the formed object 15 is formed. The base plate 2 is disposed, inside a substantially cylindrical cylinder 4 having a central axis extending in the vertical direction, so as to be vertically movable by a drive cylinder 2a. The powder bed 8 formed on the base plate 2 is newly formed by laying powder on the upper layer side every time the base plate 2 is lowered in each cycle during the shaping work.

The additive manufacturing apparatus 1 illustrated in FIG. 1 includes a powder laying unit 10 configured to lay the raw material powder 30 on a base plate 2 to form the powder bed 8. The powder laying unit 10 supplies the raw material powder 30 from the storage unit 31 to the upper surface side of the base plate 2 and flattens the surface of the raw material powder 30, thereby forming the layered powder bed 8 having a substantially uniform thickness over the entire upper surface of the base plate 2. The powder bed 8 formed in each cycle is selectively solidified by being irradiated with the light beam 65 from the light beam irradiation unit 9, and in the next cycle, the raw material powder 30 is laid again on the upper layer side by the powder laying unit 10 to form a new powder bed 8, whereby the powder beds 8 are stacked in layers.

The raw material powder 30 supplied from the powder laying unit 10 is a powdery substance serving as a raw material of the formed object 15. For example, a metal material such as iron, copper, aluminum, or titanium, or a non-metal material such as ceramic can be widely used.

The control device 20 illustrated in FIG. 1 is a control unit of the additive manufacturing apparatus 1 illustrated in FIG. 1, and is composed of an electronic computation device such as a computer, for example.

In the control device 20 illustrated in FIG. 1, information on the shape of the formed object 15, that is, the dimensions of each part, which is necessary for shaping the formed object 15, is input. Information on dimensions or the like of each part necessary for shaping the formed object 15 may be input from, for example, an external device and stored in, for example, a storage unit (not illustrated) of the control device 20. Details of control contents in the control device 20 will be described later.

Light Beam Irradiation Unit 9

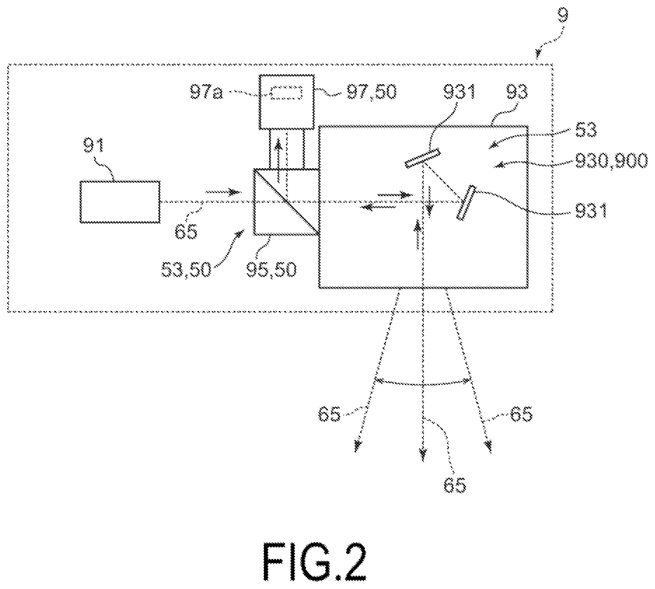

FIG. 2 is a schematic overall configuration diagram of the light beam irradiation unit 9 according to some embodiments. The light beam irradiation unit 9 according to some embodiments includes an oscillation device 91 that outputs the light beam 65, a scanning device 93 that scans the light beam 65, a beam splitter 95, and a thermometer 97.

In the light beam irradiation unit 9 according to some embodiments, the oscillation device 91 is a light beam generation unit (an example of a generation unit) that generates a light beam as an energy beam, and outputs the light beam 65 based on a control signal from the control device 20. For example, when the control signal from the control device 20 includes information on the output of the light beam 65, the oscillation device 91 outputs (emits) the light beam 65 at an output corresponding to the information.

In the following description, the scanning direction of the light beam 65 is also simply referred to as a scanning direction. Further, along the scanning direction, a direction in which the light beam 65 travels, is defined as a downstream in the scanning direction, and a side opposite to the downstream in the scanning direction along the scanning direction is defined as an upstream in the scanning direction.

In the light beam irradiation unit 9 according to some embodiments, the scanning device 93 includes a mirror 931 for scanning the light beam 65 from the oscillation device 91 and a scanning optical system 930 including a lens (not illustrated) or the like. The scanning device 93 is configured to irradiate the powder bed 8 with the light beam 65 from the oscillation device 91 while scanning the light beam 65 based on a control signal from the control device 20.

The light beam irradiation unit 9 according to some embodiments includes an irradiation optical system 900 configured to irradiate the raw material powder 30 with the light beam 65. The irradiation optical system 900 according to some embodiments includes the scanning optical system 930.

The light beam irradiation unit 9 according to some embodiments includes an information acquisition unit 50 configured to acquire information on the temperature of a region upstream of the melt pool in the scanning direction as described later. The information acquisition unit 50 includes the thermometer 97 configured to measure the temperature of a melt pool 81 on the powder bed 8 and the region in the vicinity thereof, and a measurement optical system 53 configured to guide radiation light (thermal radiation) from the melt pool on the powder bed 8 and the region in the vicinity thereof to the radiation thermometer 97.

The thermometer 97 may be, for example, a radiation thermometer. In the following description, it is assumed that the thermometer 97 is a two-color thermometer and includes a detection element 97a for detecting temperature.

In the light beam irradiation unit 9 according to some embodiments, the radiation light from the melt pool on the powder bed 8 and the region in the vicinity thereof is incident on the beam splitter 95 through the scanning mirror 931 or the like of the scanning device 93. The radiation light incident on the beam splitter 95 is reflected by the beam splitter 95 and is incident on the thermometer 97. That is, in the light beam irradiation unit 9 according to some embodiments, the measurement optical system 53 includes the beam splitter 95 and the components of the irradiation optical system 900 that are disposed closer to the powder bed 8 than the beam splitter 95 along the optical path of the light beam 65, such as the scanning mirror 931. In the light beam irradiation unit 9 according to some embodiments, a part of the measurement optical system 53 is common to at least a part of the irradiation optical system 900.

In the formation of a metal product by the additive manufacturing method, the cooling rate of a bead formed by melting metal powder with an energy beam is easily affected by the temperature of a formed object around the bead. In addition, in the formation of the metal product by the additive manufacturing method, since the metal powder as the material is heated by the energy beam as described above, heat is easily accumulated in the formed object. Therefore, in the formation of the metal product by the additive manufacturing method, the cooling rate of the bead is likely to change (decrease).

The cooling rate of the bead affects the state of the bead fiber. Therefore, in order to keep the cooling rate of the bead within an appropriate range, the additive manufacturing process is preferably monitored based on information on the cooling rate of the bead.

Therefore, in the additive manufacturing apparatus 1 according to some embodiments, as described below, the additive manufacturing process is monitored on the basis of information on the cooling rate of the bead upstream of the melt pool 81 in the scanning direction.

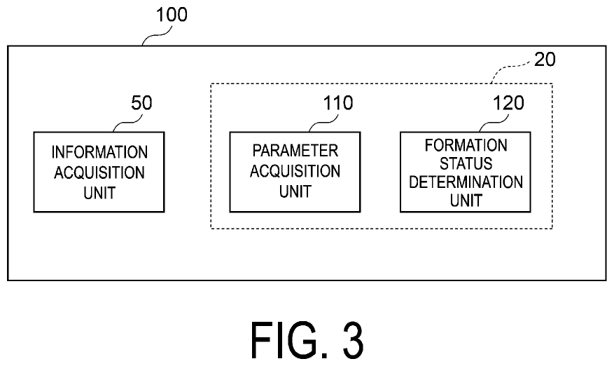

FIG. 3 is a diagram illustrating an overall configuration of an apparatus for monitoring an additive manufacturing process included in the additive manufacturing apparatus 1 according to some embodiments. The monitoring apparatus 100 illustrated in FIG. 3 includes the above-described information acquisition unit 50, a parameter acquisition unit 110, and a formation status determination unit 120 (an example of a determination unit).

### Information Acquisition Unit 50

In the monitoring apparatus 100 illustrated in FIG. 3, the information acquisition unit 50 includes the thermometer 97 and the measurement optical system 53 as described above.

In some embodiments, the thermometer 97 and the measurement optical system 53 are configured to be capable of measuring the temperature of the melt pool 81 on the powder bed 8 and the region in the vicinity thereof.

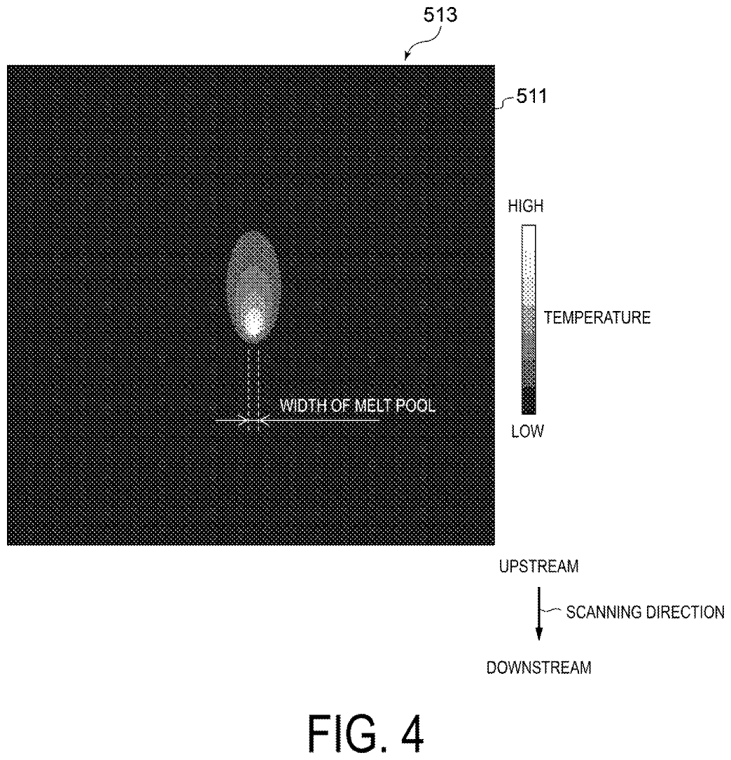

FIG. 4 is a diagram schematically illustrating a temperature distribution, of the melt pool 81 on the powder bed 8 and the region in the vicinity thereof, measured during shaping by a thermometer 97 according to some embodiments. The thermometer 97 according to some embodiments is configured to be able to simultaneously measure the temperature in the measurement region 511 as illustrated in FIG. 4. That is, information of the temperature distribution (temperature distribution information) 513 illustrated in FIG. 4 is the information on the temperature distribution in the measurement region 511 at a certain time.

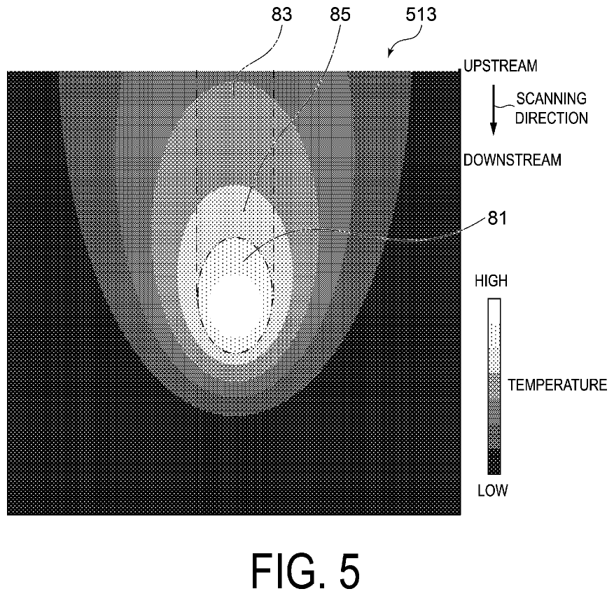

FIG. 5 is an enlarged schematic view of a region where the melt pool 81 appears in the measurement region 511 illustrated in FIG. 4. In FIG. 5, a range surrounded by a two-dot chain line is a region corresponding to the melt pool 81. In addition, in FIG. 5, a range sandwiched by two-dot chain lines from the left-right direction in the drawing is a region corresponding to a formed bead 83.

The thermometer 97 according to some embodiments acquires the temperature distribution information 513 which is the information (temperature information) on the temperature of the region 85 upstream of the melt pool 81 in the scanning direction. For convenience of description, in the following description, the region 85 is also referred to as an upstream region 85.

As described above, in some embodiments, the measurement optical system 53 is configured to cause the radiation light from the melt pool 81 on the powder bed 8 and the region in the vicinity thereof to be incident on the thermometer 97 through the scanning mirror 931 or the like of the scanning device 93 and the beam splitter 95. Therefore, the measurement region 511 of the thermometer 97 moves on the powder bed 8 along with the scanning of the light beam 65. Therefore, the position of the melt pool 81 appearing in the measurement region 511 of the thermometer 97 does not deviate from the measurement region 511 although there is some variation due to the influence of the optical path length which differs depending on the scanning position. Therefore, in the thermometer 97 according to some embodiments is not required to simultaneously measure the temperature of the entire upper surface of the powder bed 8, and is only required to measure the temperature of a limited range including the melt pool 81. In this way, by limiting the measurement region 511 of the thermometer 97 not to the entire upper surface of the powder bed 8 but to the region of the melt pool 81 on the powder bed 8 and the region in the vicinity thereof, it is possible to reduce the load of the processing described later in the parameter acquisition unit 110. Accordingly, it is possible to suppress a delay in processing when processing described later in the parameter acquisition unit 110 is performed in real time during additive manufacturing.

Parameter Acquisition Unit 110

In the monitoring apparatus 100 illustrated in FIG. 3, the parameter acquisition unit 110 is one of functional blocks realized by a program executed by an electronic computation device (not illustrated) of the control device 20.

In some embodiments, the parameter acquisition unit 110 is configured to acquire a parameter (cooling rate parameter) P indicating the cooling rate of the upstream region 85 on the basis of information on the temperature of the upstream region 85. The contents of the processing in the parameter acquisition unit 110 will be described below.

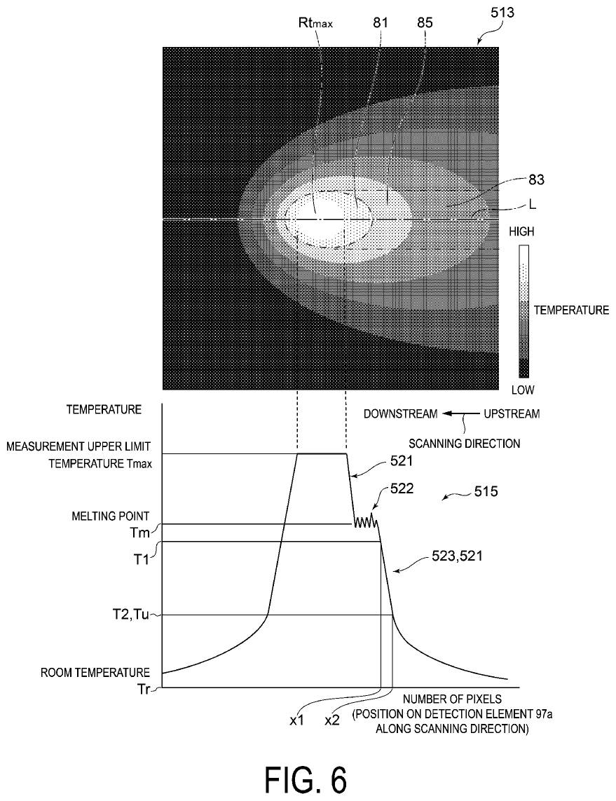

FIG. 6 is a diagram for describing contents of processing in the parameter acquisition unit 110, and is a diagram illustrating the temperature distribution information 513 illustrated in FIG. 5 and a graph 515 illustrating a relationship between a position and a temperature along the scanning direction that are extracted from the temperature distribution information 513.

The parameter acquisition unit 110 specifies a region Rtmax having the highest temperature and the scanning direction in the temperature distribution information 513 acquired by the information acquisition unit 50. Then, the parameter acquisition unit 110 extracts the temperature on the line segment L passing through the region Rtmax having the highest temperature and extending in the scanning direction in the temperature distribution information 513. A graph 515 in FIG. 6 is a graph illustrating the temperature extracted in this manner.

In the graph 515 of FIG. 6, the horizontal axis represents the position along the direction corresponding to the scanning direction on the detection element 97a of the thermometer 97 by, for example, the number of pixels of the detection element 97a. The vertical axis represents the temperature measured at each position along the direction corresponding to the scanning direction on the detection element 97a.

Since the temperature exceeding the measurement upper limit temperature Tmax of the thermometer 97 cannot be measured, even when the actual temperature exceeds the measurement upper limit temperature Tmax of the thermometer 97, the actual temperature is illustrated as the measurement upper limit temperature Tmax in the graph 515 of FIG. 6.

Next, based on the graph 515 of FIG. 6, the parameter acquisition unit 110 obtains, as a cooling rate parameter P, a temperature difference ΔT with respect to a position difference Δx in the scanning direction at a certain time t.

The temperature difference ΔT with respect to the position difference Δx in the scanning direction at a certain time t is the temperature difference ΔT with respect to the position difference Δx in the scanning direction on the powder bed 8, and can be obtained as follows, for example.

For example, in the graph 515 of FIG. 6, in the scanning direction, downstream of the region Rtmax at which the temperature is highest, the position, on the detection element 97a, at which the temperature T1 immediately below the melting point Tm is detected is defined as the position x1, and the position, on the detection element 97a, at which the temperature T2 lower than the temperature T1 is detected is defined as the position x2.

The temperature T2 is a temperature in the region where the temperature decreases at a substantially constant rate from the temperature T1.

In some embodiments, the parameter acquisition unit 110 obtains the temperature difference ΔT with respect to the position difference Δx in the scanning direction at a certain time t as the change amount in temperature per pixel on the detection element 97a, ΔT′/Δx′.

The change amount in temperature per pixel on the detection element 97a, ΔT′/Δx′, is expressed by the following equation (1).

ΔT′/Δx′[° C./pixel]=(T2−T1)/(|x1−x2|) (1)

Here, |x1−x2| is the number of pixels between the position x1 and the position x2 on the detection element 97a.

When the scanning rate Vs is constant and known in advance, a cooling rate Vc can be obtained from the change amount in temperature per pixel on the detection element 97a, ΔT′/Δx′. The procedure for obtaining the cooling rate Vc will be described later.

### Formation Status Determination Unit 120

In the monitoring apparatus 100 illustrated in FIG. 3, the formation status determination unit 120 is one of functional blocks realized by a program executed by an electronic computation device (not illustrated) of the control device 20.

In some embodiments, the formation status determination unit 120 is configured to determine the formation status based on the cooling rate parameter P acquired by the parameter acquisition unit 110. Hereinafter, contents of processing in the formation status determination unit 120 will be described.

The formation status determination unit 120 calculates the cooling rate Vc of the upstream region 85 as follows based on, the temperature difference ΔT with respect to the position difference Δx in the scanning direction at a certain time t, which has been obtained as the cooling rate parameter P, that is, the above-described change amount ΔT′/Δx′, and the scanning rate Vs of the light beam 65.

Let c (pixels/mm) be a coefficient that represents the number of pixels on the detection element 97a to which the length of 1 mm along the scanning direction on the powder bed 8 corresponds. Let Vs (mm/sec) be a scanning rate.

In this case, the cooling rate Vc can be obtained by multiplying ΔT′/Δx′ (the change amount in temperature per pixel on the detection element 97a) by the above coefficient c and the scanning rate Vs, as expressed by the following equation (2).

Vc[° C./sec]={(t2−t1)/(|x1−x2|)}×c×Vs (2)

Thus, according to some embodiments, the cooling rate Vc of the upstream region 85 can be calculated when the scanning rate is constant and known in advance.

The formation status determination unit 120 compares the cooling rate Vc obtained as described above with a threshold value Vth of the cooling rate stored in advance in a storage device (not illustrated).

For example, when the cooling rate Vc obtained as described above is equal to or higher than the threshold value Vth, the formation status determination unit 120 determines that the formation status is favorable judging that the cooling rate Vc is maintained within an appropriate range from the viewpoint of maintaining the state of the fiber of the bead 83 in a desired state.

For example, when the cooling rate Vc obtained as described above is less than the threshold value Vth, the formation status determination unit 120 determines that the formation status is defective judging that the cooling rate Vc is deviated from an appropriate range from the viewpoint of maintaining the state of the fiber of the bead 83 in a desired state.

As described above, in some embodiments, the formation status determination unit 120 determines whether the cooling rate Vc is within the management range based on the temperature distribution upstream of the melt pool 81 in the scanning direction.

Since it is sufficient that the cooling rate Vc described above can be obtained, the temperature information may include temperatures at at least two points having different positions in the scanning direction.

In the monitoring apparatus 100 illustrated in FIG. 3, when the formation status determination unit 120 determines that the formation status is favorable, the control device 20 controls each unit of the additive manufacturing apparatus 1 to continue the shaping.

In the monitoring apparatus 100 illustrated in FIG. 3, when the formation status determination unit 120 determines that the formation status is defective, the control device 20 controls each unit of the additive manufacturing apparatus 1 so as to suspend shaping, that is, irradiation of the light beam 65, until the temperature of the formed object 15 decreases to a predetermined temperature.

In the monitoring apparatus 100 illustrated in FIG. 3, when the formation status determination unit 120 determines that the formation status is defective, the control device 20 may control each unit of the additive manufacturing apparatus 1 so as to suspend shaping, that is, the irradiation of the light beam 65, until a predetermined standby time elapses.

### Temperature Range Suitable for Acquisition of Cooling Rate Parameter P

The range of the upstream region 85 for acquiring the cooling rate parameter P may be upstream in the scanning direction of the position where the temperature is equal to the melting point Tm of the raw material.

Accordingly, the cooling rate parameter P in the temperature region that affects the state of the fiber can be obtained, and the state of the fiber can be determined based on the cooling rate parameter P.

In the graph 515 of FIG. 6, when the upstream region 85 includes the first region 521 in which the temperature monotonically decreases toward upstream in the scanning direction and the second region 522 in which the temperature does not monotonically decrease toward upstream in the scanning direction, the parameter acquisition unit 110 may acquire information on the temperature of the third region 523 in which the temperature monotonically decreases toward upstream in the scanning direction, in the upstream of the second region 522 in the scanning direction.

In the case where the raw material powder 30 is a pure metal powder, when the raw material powder 30 heated and melted by the light beam 65 is cooled and solidified, the temperature monotonically decreases with time until the temperature reaches the melting point Tm. When the temperature decreases to the melting point Tm, a phenomenon in which the temperature hardly changes with time, that is, the temperature does not monotonically decrease with time, appears. After that, the temperature monotonically decreases again.

Further, in the case where the raw material powder 30 is an alloy, when the raw material powder 30 heated and melted by the light beam 65 is cooled and solidified, the temperature monotonically decreases with time until the temperature reaches the melting point Tm as in the case where the raw material is a pure metal. When the temperature decreases to the melting point, a phenomenon in which the temperature slightly increases or decreases with time, that is, a phenomenon in which the temperature does not monotonically decrease with time appears. Thereafter, as in the case where the raw material powder 30 is pure metal, the temperature monotonically decreases again.

Therefore, the temperature of the second region 522 is around the melting point Tm. Further, the temperature of the third region 523 is lower than the melting point Tm, and the cooling rate in the third region 523, particularly the cooling rate Vc in a temperature region relatively close to the melting point Tm, affects the state of the fiber of the bead 83.

Therefore, the parameter acquisition unit 110 can acquire the temperature information on the temperature lower than the melting point Tm, that is, the temperature information in the temperature region where the cooling rate Vc affects the state of the fiber of the bead 83 by acquiring the information on the temperature of the third region 523. Thus, it is possible to calculate the cooling rate suitable for grasping the state of the fiber of the bead 83. Therefore, the state of the fiber of the bead 83 can be accurately grasped.

In addition, in the graph 515 of FIG. 6, the parameter acquisition unit 110 may acquire information on the temperature of a region, within the third region 523, which has a temperature equal to or higher than a temperature that is lower than the temperature of the second region 522 by half the temperature difference between the temperature of the second region 522 and a room temperature Tr.

In the third region 523, a temperature Tu that is lower than the temperature (≈Tm) of the second region 522 by a temperature {(Tm−Tr)/2} that is one half of the temperature difference between the temperature (≈Tm) of the second region 522 and the room temperature Tr may be set as a lower limit. Then information on the temperature of a region having a temperature equal to or higher than the temperature Tu may be acquired.

This makes it possible to acquire information on the temperature of a region, within the third region 523, which has a temperature relatively close to the melting point Tm in particular. Accordingly, it is possible to more accurately grasp the state of the fiber of the bead 83.

### Flowchart

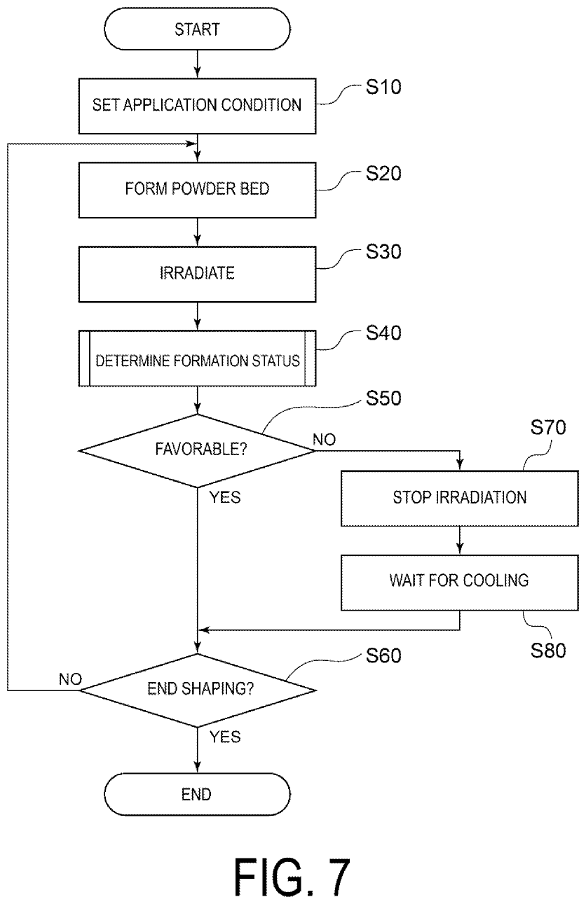

FIG. 7 is a flowchart illustrating a processing procedure of an additive manufacturing method when the additive manufacturing apparatus 1 including the monitoring apparatus 100 according to some embodiments described above shapes the formed object 15.

The additive manufacturing method according to some embodiments illustrated in FIG. 7 includes an application condition setting step S10, a powder bed forming step S20, an irradiation step S30, and a formation status determination step S40. The additive manufacturing method according to some embodiments illustrated in FIG. 7 includes an irradiation stop step S70 and a cooling waiting step S80.

### Application Condition Setting Step S10

The application condition setting step S10 is a step for setting information necessary for shaping the formed object 15. In the application condition setting step S10, as described above, information necessary for shaping the formed object 15, which are the shape of the formed object 15, that is, the dimensions of each part, is input to the control device 20, and is stored in the storage unit (not illustrated). Information on dimensions or the like of each part necessary for shaping the formed object 15 may be input from, for example, an external device and stored in, for example, a storage unit (not illustrated) of the control device 20. Additionally, the operator may input necessary information by operating an input device (not illustrated).

Here, the information input to the control device 20 includes, in addition to the above-described information, information on the output of the light beam 65, the scanning rate Vs, or the like, the value of the above-described coefficient c, information of a temperature range related to acquisition of information on the temperature based on the composition of the raw material powder 30, or the like.

### Powder Bed Forming Step S20

The powder bed forming step S20 is a step of forming the powder bed 8 by supplying the raw material powder 30. That is, the powder bed forming step S20 is a step of supplying the raw material powder 30 from the storage unit 31 to the powder bed 8 and laminating the raw material powder 30 by a prescribed thickness.

To be specific, the control device 20 according to some embodiments controls the drive cylinder 2a so that the base plate 2 is lowered by a lowering amount equal to the above-described prescribed thickness.

Next, the control device 20 according to some embodiments controls the powder laying unit 10 so as to supply the raw material powder 30 to the upper surface side of the base plate 2.

By performing the powder bed forming step S20, a layer of the raw material powder 30 laminated by a prescribed thickness is formed on the upper portion of the powder bed 8.

### Irradiation Step S30

The irradiation step S30 is a step of irradiating the raw material powder 30 forming the powder bed 8 with the light beam 65.

Specifically, the control device 20 according to some embodiments controls the light beam irradiation unit 9 to irradiate the powder bed 8 with the light beam 65 while scanning the powder bed 8 with the light beam 65.

That is, in the irradiation step S30, the raw material powder 30 on the powder bed 8, which is laminated by the prescribed thickness as described above, is irradiated with the light beam 65 while the light beam 65 is scanning, and is melted and solidified, thereby shaping a part of the formed object 15.

More specifically, the control device 20 according to some embodiments controls the light beam irradiation unit 9 to perform irradiation while scanning the light beam 65 at a predetermined output of the light beam 65 and a predetermined scanning rate.

By performing the irradiation step S30, a part of the formed object 15 is newly formed on the upper portion of the powder bed 8 by a thickness corresponding to the prescribed thickness.

### Formation Status Determination Step S40

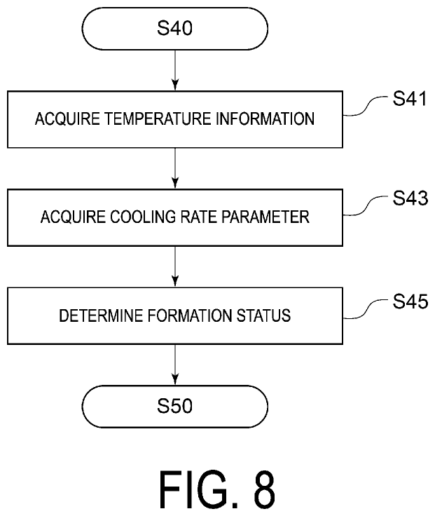

The formation status determination step S40 is a step of calculating the cooling rate parameter P described above and determining the quality of the formation status based on the calculated cooling rate parameter P. In the formation status determination step S40, the quality of the formation status is determined by executing a subroutine illustrated in FIG. 8.

FIG. 8 is a flowchart illustrating a processing procedure of the subroutine of the formation status determination step S40.

The subroutine of the formation status determination step S40 includes a temperature information acquisition step S41, a cooling rate parameter acquisition step S43, and a formation status determination step S45.

### Temperature Information Acquisition Step S41

The temperature information acquisition step S41 is a step of acquiring temperature distribution information 513 that is information (temperature information) on the temperature of the region 85 upstream of the melt pool 81 in the scanning direction. In the temperature information acquisition step S41, the thermometer 97 acquires the temperature distribution information 513 in the upstream region 85 as described above.

### Cooling Rate Parameter Acquisition Step S43

The cooling rate parameter acquisition step S43 is a step of acquiring a parameter (cooling rate parameter) P indicating the cooling rate of the upstream region 85, based on the temperature distribution information 513 that is information (temperature information) on the temperature of the upstream region 85. In the cooling rate parameter acquisition step S43, the parameter acquisition unit 110 acquires the cooling rate parameter P as described above.

### Formation Status Determination Step S45

The formation status determination step S45 is a step of determining the formation status based on the cooling rate parameter P. In the formation status determination step S45, the formation status determination unit 120 calculates the cooling rate Vc of the upstream region 85 based on the cooling rate parameter P, for example, as described above. That is, the preceding stage of the formation status determination step S45 is a step of calculating the cooling rate Vc of the upstream region 85.

Then, in the formation status determination step S45, for example, when the calculated cooling rate Vc is equal to or higher than the threshold value Vth, the formation status determination unit 120 determines that the formation status is favorable judging that the cooling rate Vc is maintained within an appropriate range from the viewpoint of maintaining the state of the fiber of the bead 83 in a desired state.

For example, in the formation status determination step S45, when the calculated cooling rate Vc is less than the threshold value Vth, the formation status determination unit 120 determines that the formation status is defective judging that the cooling rate Vc is deviated from an appropriate range from the viewpoint of maintaining the state of the fiber of the bead 83 in a desired state.

When it is determined that the formation status is favorable in the formation status determination step S45, the step S50 is affirmatively determined, and the process proceeds to the step S60.

In the step S60, the control device 20 determines whether the additive manufacturing is completed.

When the additive manufacturing is completed, the processing in thi s flowchart ends.

When the additive manufacturing is not completed, the control device 20 returns to the powder bed forming step S20 and controls each unit so that the raw material powder 30 is laminated by a prescribed thickness.

### Irradiation Stop Step S70

When it is determined that the formation status is defective in the formation status determination step S45, the step S50 is negatively determined, and the process proceeds to the irradiation stop step S70.

The irradiation stop step S70 is a step of stopping the irradiation of the light beam 65. In the irradiation stop step S70, the control device 20 controls each unit of the additive manufacturing apparatus 1 such as outputting a control signal to the oscillation device 91 of the light beam irradiation unit 9 so as to suspend the irradiation of the light beam 65.

### Cooling Waiting Step S80

The cooling waiting step S80 is a step of waiting for the temperature of the formed object 15 to decrease, after the irradiation of the light beam 65 is stopped in the irradiation stop step S70. In the cooling waiting step S80, the control device 20 controls each unit of the additive manufacturing apparatus 1 so as to wait until the temperature of the formed object 15 measured by, for example, the thermometer 97 decreases to a predetermined temperature. For example, when the control device 20 determines that the temperature of the formed object 15 measured by, for example, the thermometer 97 is equal to or lower than a predetermined temperature, the process proceeds to step S60, and the control device 20 determines whether the additive manufacturing is completed.

As described above, in the cooling waiting step S80, the control device 20 may control each unit of the additive manufacturing apparatus 1 to wait until a predetermined standby time elapses, for example. In this case, the control device 20 proceeds to the step S60 after a predetermined standby time, and determines whether the additive manufacturing is completed.

The present disclosure is not limited to the above-described embodiments, and includes embodiments obtained by modifying the above-described embodiments and embodiments obtained by appropriately combining these embodiments.

For example, the additive manufacturing process monitoring method according to some embodiments described above has been described as an application example in a case where the additive manufacturing method by the powder bed method is performed. However, the additive manufacturing process monitoring method is also applicable to an additive manufacturing method by direct energy deposition (DED).

In the method of monitoring an additive manufacturing process according to some embodiments described above, the cooling rate parameter P is obtained as the change amount in temperature per pixel on the detection element 97a, ΔT′/Δx′, and the cooling rate Vc is obtained from the change amount ΔT′/Δx′. Then, the obtained cooling rate Vc is compared with a predetermined cooling rate threshold value Vth to determine the quality of the formation status.

However, for example, the quality of the formation status may be determined without obtaining the cooling rate Vc. Specifically, for example, the quality of the formation status may be determined by comparing the change amount obtained as the cooling rate parameter P, ΔT′/Δx′ with a predetermined threshold value Ath for the change amount. The threshold value Ath in this case is the change amount in temperature per pixel, ΔTth′/Δx′, which corresponds to the threshold value Vth of the cooling rate.

In some embodiments described above, although not particularly specified, in the light beam irradiation unit 9 illustrated in FIG. 2, the oscillation device 91 is configured to output the light beam 65 having an intensity distribution of a TEMoo mode called, for example, a Gaussian beam. However, for example, in the case of using a raw material powder 30 which is suitable to be applied at a low cooling rate, the light beam 65 output from the oscillation device 91 may be converted into, for example, a light beam having a high-order mode of a second order or more, a top hat-formed intensity distribution, or the like by a conversion device. Accordingly, the intensity distribution of the light beam 65 on the powder bed 8 is changed, and the light beam 65 is irradiated in a wider range. Therefore, the formed object 15 is likely to be warmed, and the cooling rate is decreased.

However, even in this case, it is preferable to determine whether the cooling rate Vc is within the management range as described above.

The contents described in the above embodiments are understood as follows, for example.

(1) A method of monitoring an additive manufacturing process according to at least one embodiment of the present disclosure includes the steps of, acquiring information on a temperature of a region (upstream region 85) upstream, in a scanning direction of a light beam 65, of a melt pool 81 that is formed by irradiating a raw material (raw material powder 30) with the light beam 65 as an energy beam (temperature information acquisition step S41), acquiring a parameter (cooling rate parameter) P indicating a cooling rate Vc of the upstream region 85 based on the information on the temperature (cooling rate parameter acquisition step S43), and determining a formation status based on the cooling rate parameter P (formation status determination step S45).

According to the above method (1), the temperature information of the upstream region 85 is acquired, and the cooling rate parameter P indicating the cooling rate Vc of the upstream region 85 is acquired based on the temperature information of the upstream region 85. Therefore, information necessary for maintaining the cooling rate Vc of the bead 83 within an appropriate range is obtained. Then, in the formation status determination step S45, the quality of the formation status can be determined based on the cooling rate parameter P. This contributes to improving the quality of the formed object 15 in additive manufacturing.

(2) In some embodiments, in the above method (1), the above information on the temperature may include temperatures at the same time at at least two points that are in different positions along the scanning direction in at least the upstream region 85.

According to the above method (2), since it is not necessary to obtain information at different times, it is possible to shorten the time required for obtaining the cooling rate parameter P indicating the cooling rate Vc of the upstream region 85.

Thus, the formation status can be quickly determined.

(3) In some embodiments, in the above method (1) or (2), in the cooling rate parameter acquisition step S43, a temperature difference ΔT with respect to a position difference Δx in the scanning direction at a certain time t is obtained as the cooling rate parameter P, based on the above information on the temperature.

According to the above method (3), the cooling rate parameter P indicating the cooling rate Vc of the upstream region 85 is acquired by obtaining the temperature difference ΔT with respect to the position difference Δx in the scanning direction at the certain time t.

(4) In some embodiments, the above method (3) further includes a step (preceding stage of the formation status determination step S45) of calculating a cooling rate Vc of the upstream region 85 based on the temperature difference ΔT and a scanning rate Vs of the light beam 65.

As described above, when the scanning rate Vs is constant and known in advance, the time required for the temperature to decrease by the temperature difference ΔT can be obtained from the position difference Δx in the scanning direction at a certain time t. That is, according to the above method (4), when the scanning rate Vs is constant and known in advance, the cooling rate Vc of the upstream region 85 can be calculated.

(5) In some embodiments, in any one of the above methods (1) to (4), the upstream region 85 is upstream in the scanning direction of a position that has a temperature equal to a melting point Tm of the raw material.

According to the above method (5), it is possible to acquire a parameter indicating the cooling rate Vc in a temperature region that affects the state of the fiber. Thus, the state of the fiber can be determined based on the parameter.

(6) In some embodiments, in any one of the above methods (1) to (5), in the temperature information acquisition step S41, when the upstream region 85 includes a first region 521 in which the temperature monotonically decreases toward upstream in the scanning direction and a second region 522 in which the temperature does not monotonically decrease toward upstream in the scanning direction information on the temperature of a third region 523, in which the temperature monotonically decreases toward upstream in the scanning direction in the upstream of the second region 522 in the scanning direction, is acquired.

According to the above method (6), in the temperature information acquisition step S41, the information on the temperature lower than the melting point Tm, that is, the temperature information in the temperature region where the cooling rate Vc affects the state of the fiber of the bead 83 can be acquired. Thus, the state of the fiber of the bead can be accurately grasped.

(7) In some embodiments, in the above method (6), in the temperature information acquisition step S41, within the third region 523, information on the temperature of a region, in which the temperature is equal to or higher than a temperature that is lower than the temperature of the second region 522 by half the temperature difference between the temperature of the second region 522 and a room temperature Tr, is acquired.

According to the above method (7), within the third region 523, by setting, as a lower limit, a temperature Tu that is lower than the temperature of the second region 522 by half the temperature difference between the temperature of the second region 522 and the room temperature Tr, it is possible to acquire the information on the temperature of a region that has a temperature equal to or higher than the temperature Tu. That is, according to the above method (7), it is possible to acquire the information on the temperature of a region, within the third region 523, which has a temperature relatively close to the melting point Tm in particular. This makes it possible to more accurately grasp the state of the fiber of the bead.

(8) An additive manufacturing method according to at least one embodiment of the present disclosure includes the steps of, irradiating a raw material (raw material powder 30) with a light beam 65 as an energy beam (irradiation step S30), and determining a formation status by the method of monitoring an additive manufacturing process according to any one of the above (1) to (7) (formation status determination step S40).

According to the above method (8), since the step (formation status determination step S40) of determining the formation status by the method of monitoring an additive manufacturing process according to any one of the above (1) to (7) is provided, the quality of the formation status can be determined based on the cooling rate parameter P indicating the cooling rate Vc of the upstream region 85. This can improve the quality of the formed object 15 in additive manufacturing.

(9) In some embodiments, in the above method (8), when it is determined that the formation status is defective in the formation status determination step S40, the irradiation of the light beam 65 is suspended in the irradiation step S30.

According to the above method (9), it is possible to lower the temperature of the formed object 15 during shaping by suspending the irradiation of the light beam 65. This prevents the cooling rate Vc of the upstream region 85 from being lower than an appropriate range.

(10) An apparatus 100 of monitoring an additive manufacturing process according to at least one embodiment of the present disclosure includes, an information acquisition unit 50 configured to acquire information on a temperature of a region (upstream region 85) upstream, in a scanning direction of an light beam 65, of a melt pool 81 that is formed by irradiating a raw material (raw material powder 30) with the light beam 65 as the energy beam, a parameter acquisition unit 110 configured to acquire a parameter indicating a cooling rate Vc of the upstream region 85 based on the information on the temperature of the upstream region 85, and a determination unit (formation status determination unit 120) configured to determine a formation status based on the parameter.

According to the above configuration (10), the information on the temperature of the upstream region 85 is acquired, and the parameter indicating the cooling rate Vc of the upstream region 85 is acquired based on the information on the temperature of the upstream region 85. Therefore, information necessary for maintaining the cooling rate Vc of the bead 83 within an appropriate range is obtained. Then, in the formation status determination unit 120, the quality of the formation status can be determined based on the parameter. This contributes to improving the quality of the formed object 15 in additive manufacturing.

(11) An additive manufacturing apparatus 1 according to at least one embodiment of the present disclosure includes, an energy beam irradiation unit (light beam irradiation unit) 9 that can irradiate the raw material (raw material powder 30) with the light beam 65 as an energy beam, and the apparatus 100 of monitoring an additive manufacturing process according to the above configuration (10).

According to the above configuration (11), since the apparatus 100 of monitoring an additive manufacturing process according to the above configuration (10) is provided, the quality of the formation status can be determined based on the parameter indicating the cooling rate Vc of the upstream region 85. This can improve the quality of the formed object 15 in additive manufacturing.

(12) In some embodiments, in the above configuration (11), a measurement optical system 53 configured to acquire the above information on the temperature is further provided. The energy beam irradiation unit 9 includes a generation unit (oscillation device 91) configured to generate the light beam 65 as an energy beam, and an irradiation optical system 900 configured to irradiate the raw material (raw material powder 30) with the light beam 65. A part of the measurement optical system 53 is common to at least a part of the irradiation optical system 900.

According to the above configuration (12), it is possible to suppress complication of the configuration of the optical system in the additive manufacturing apparatus 1.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A method of monitoring an additive manufacturing process, comprising the steps of:
(a) acquiring information on a temperature of a region upstream of a melt pool in a scanning direction of an energy beam, the melt pool being formed by irradiating a raw material with the energy beam;
(b) acquiring a parameter indicating a cooling rate of the region based on the information on the temperature; and
(c) determining a formation state based on the parameter.

2. The method of monitoring an additive manufacturing process according to claim 1, wherein
the information on the temperature includes temperatures at the same time at at least two points that are in different positions along the scanning direction in at least the region.

3. The method of monitoring an additive manufacturing process according to claim 1, wherein
in the step (b) acquiring the parameter, a difference in temperature with respect to a difference in position in the scanning direction at a certain time is obtained as the parameter, based on the information on the temperature.

4. The method of monitoring an additive manufacturing process according to claim 3, further comprising a step of:
(d) calculating a cooling rate of the region based on the difference in temperature and a scanning rate of the energy beam.

5. The method of monitoring an additive manufacturing process according to claim 1, wherein
the region is upstream in the scanning direction of a position that has a temperature equal to a melting point of the raw material.

6. The method of monitoring an additive manufacturing process according to claim 1, wherein
in the step (a) acquiring information on the temperature, when the region includes a first region in which the temperature monotonically decreases further upstream in the scanning direction and a second region in which the temperature does not monotonically decrease further upstream in the scanning direction, information on the temperature of a third region is acquired, the third region being a region in which the temperature monotonically decreases further upstream in the scanning direction upstream of the second region in the scanning direction.

7. The method of monitoring an additive manufacturing process according to claim 6, wherein
in the step (a) acquiring information on the temperature, information on the temperature of a region within the third region is acquired, where the region has a temperature equal to or higher than a temperature that is lower than the temperature of the second region by half the temperature difference between the temperature of the second region and a room temperature.

8. An additive manufacturing method, comprising the steps of:
(e) irradiating a raw material with an energy beam; and
(f) determining a formation state by using the method of monitoring an additive manufacturing process of claim 1.

9. The additive manufacturing method according to claim 8, wherein in the step (e) irradiating with the energy beam, when it is determined that the formation status is defective in the step (f) determining the formation status, irradiation of the energy beam is suspended.

10. An apparatus for monitoring an additive manufacturing process, comprising:
an information acquisition unit configured to acquire information on a temperature of a region upstream of a melt pool in a scanning direction of an energy beam, the melt pool being formed by irradiating a raw material with the energy beam;
a parameter acquisition unit configured to acquire a parameter indicating a cooling rate of the region based on the information on the temperature of the region; and
a determination unit configured to determine a formation status based on the parameter.

11. An additive manufacturing apparatus, comprising:
an energy beam irradiation unit capable of irradiating a raw material with an energy beam; and
the apparatus for monitoring an additive manufacturing process of claim 10.

12. The additive manufacturing apparatus according to claim 11, further comprising:
a measurement optical system configured to acquire information on the temperature, wherein
the energy beam irradiation unit includes a generation unit configured to generate a light beam as the energy beam and an irradiation optical system configured to irradiate the raw material with the light beam, and
a part of the measurement optical system is common to at least a part of the irradiation optical system.
